(19) United States
(12) Patent Application Publication
(10) Pub. No.: US 2026/0063941 A1
(43) Pub. Date: Mar. 5, 2026

(54) TRANSPARENT LIQUID CRYSTAL DISPLAY DEVICE

(71) Applicant: Japan Display Inc., Tokyo (JP)

(72) Inventors: Kazuki ICHIHARA, Tokyo (JP); Takeo KOITO, Tokyo (JP)

(73) Assignee: Japan Display Inc., Tokyo (JP)

(21) Appl. No.: 19/310,093

(22) Filed: Aug. 26, 2025

(30) Foreign Application Priority Data
Aug. 30, 2024 (JP) 2024-149821

(51) Int. Cl. G02F 1/1333; G02F 1/1347; G02F 1/139; G09G 3/36

(52) U.S. Cl. CPC G02F 1/133342; G02F 1/1347; G02F 1/1396; G09G 3/3648; G02F 2203/01; G09G 2300/023; G09G 2320/0666; G09G 2320/0686; G09G 2340/125

(57) ABSTRACT

There is provided a transparent liquid crystal display device including a transparent liquid crystal display, two TN liquid crystal displays, and a general controller. The general controller performs display control to repeat a first display period and a second display period. In the first display period, the general controller displays first information to be displayed on a first surface side on the transparent liquid crystal display, causes one TN liquid crystal display to transition to a transparent state, and causes the other TN liquid crystal display to transition to a black display state. In the second display period, the general controller displays second information to be displayed on a second surface side on the transparent liquid crystal display, causes the one TN liquid crystal display to transition to the black display state, and causes the other TN liquid crystal display to transition to the transparent state.

### CROSS REFERENCES TO RELATED APPLICATIONS

The present application claims priority to Japanese Patent Application No. 2024-149821 filed on Aug. 30, 2024, the disclosure of which is incorporated herein by reference.

### BACKGROUND

The present invention relates to a transparent liquid crystal display device.

A transparent display device that enables a user to visually recognize information such as an image from a first surface and a second surface facing the first surface is known.

U.S. Patent Application Publication No. 2012/0019434

### SUMMARY

According to the transparent display device of the above technique, a user on the first surface side and a user on the second surface side facing the first surface can respectively recognize an image or the like. However, since the same image is visually recognized from each of the first surface and the second surface, there is a case where an appropriate image is displayed on one surface but an appropriate image is not displayed on the other surface. Such an event is more easily understood, for example, when considering a case where characters are displayed. That is, in a character image displayed on one side, a user can recognize a character by the character image, but in a character image displayed on the other side, it is difficult for a user to recognize the character by the character image since the character appears on the back side.

In a transparent liquid crystal display device, it is desired to display appropriate information on each of both display surfaces.

According to one embodiment a transparent liquid crystal display device includes a transparent liquid crystal display unit that has a first surface and a second surface opposite to the first surface; a first display unit; a second display unit; and a control unit that performs display control of the transparent liquid crystal display unit, the first display unit, and the second display unit. The transparent liquid crystal display unit includes: a first substrate having the first surface; a second substrate having the second surface; a display layer that is disposed between the first substrate and the second substrate and transitions between a transparent state in which light is transmitted and a display state in which information is displayed; and a display area that is provided in an area where the first substrate, the second substrate, and the display layer overlap each other, and the information is displayed to be visually recognized from the first surface side and the second surface side. In the first display unit, one surface of a substrate is disposed on the first surface, and transition for an area that covers the display area is performed between a black display state in which black is displayed and a transparent state in which light is transmitted. In the second display unit, one surface of a substrate is disposed on the second surface, and transition for an area that covers the display area is performed between a black display state in which black is displayed and a transparent display state in which light is transmitted. The control unit is configured to: perform display control to repeat a first display period and a second display period; in the first display period, display first information to be displayed on the first surface side on the transparent liquid crystal display unit; cause the first display unit to transition to the transparent state, and cause the second display unit to transition to the black display state; and in the second display period, display second information to be displayed on the second surface side on the transparent liquid crystal display unit; cause the first display unit to transition to the black display state; and cause the second display unit to transition to the transparent state.

### BRIEF DESCRIPTION OF THE DRAWINGS

FIG. 1 is a schematic diagram illustrating an example of a configuration of a transparent liquid crystal display device according to a first embodiment.

FIG. 2 is a diagram illustrating an example of a configuration of a transparent liquid crystal display according to the first embodiment.

FIG. 3 is a perspective view illustrating an outline of an example of a configuration of a main body of the transparent liquid crystal display according to the first embodiment.

FIG. 4 is a cross-sectional view taken along line A-A in FIG. 3.

FIG. 5 is an example of a configuration of a circuit formed in the main body of the transparent liquid crystal display according to the first embodiment.

FIG. 6 is a schematic diagram illustrating an example of a first double-sided viewing state according to the first embodiment.

FIG. 7 is a schematic diagram illustrating an example of a single-sided viewing state according to the first embodiment.

FIG. 8 is a schematic diagram illustrating an example of a single-sided viewing state according to the first embodiment.

FIG. 9 is a diagram illustrating an example of high-speed switching control according to the first embodiment.

FIG. 10 is a diagram for explaining an example of display of the transparent liquid crystal display device according to the first embodiment.

FIG. 11 is a diagram for explaining an operation of the transparent liquid crystal display device according to the first embodiment.

FIG. 12 is a diagram for explaining a modification example of display control according to the first embodiment.

FIG. 13 is a schematic diagram illustrating an example of a configuration of a transparent liquid crystal display device according to a second embodiment.

FIG. 14 is a schematic diagram illustrating an example of display control of the transparent liquid crystal display device according to the second embodiment.

FIG. 15 is a schematic diagram illustrating an example of display control of the transparent liquid crystal display device according to the second embodiment.

FIG. 16 is a schematic diagram illustrating an example of display control of the transparent liquid crystal display device according to the second embodiment.

FIG. 17 is a diagram illustrating an example of high-speed switching control according to the second embodiment.

### DETAILED DESCRIPTION

Hereinafter, embodiments will be described with reference to the drawings.

Note that the present disclosure is merely an example, and any modifications that can be easily conceived by those skilled in the art while maintaining the gist of the present disclosure are naturally included within the scope of the present disclosure.

In addition, in order to make the description clearer, the drawings may schematically represent a width, a thickness, a shape, and the like of each portion as compared with an actual aspect, but are merely examples, and do not limit interpretation of the present disclosure. In the present specification and each drawing, the same reference numerals are given to the same elements as those illustrated in the previous drawings, and the detailed description may be appropriately omitted.

For the description, in a case of describing processing by a program, a program, a function, a processing unit, or the like may be described as a main entity. However, a main hardware entity for the program, the function, the processing unit, or the like is a processor, or a controller, a device, a computer, equipment, or the like including a processor and the like. The computer executes processing according to the program that is read on a memory by the processor while appropriately using resources such as a memory and a communication interface. Thereby, a predetermined function, a processing unit, and the like are realized. The processor includes, for example, a semiconductor device such as a CPU/MPU or a GPU. The processing is not limited to software program processing, and can be implemented by a dedicated circuit. As the dedicated circuit, an FPGA, ASIC, CPLD, or the like can be applied.

The program may be installed in a target computer in advance as data, or may be distributed from a program source to a target computer as data. The program source may be a program distribution server on a communication network, or may be a non-transitory computer-readable storage medium, for example, a memory card or a disk. The program may include a plurality of modules. The computer device may include a plurality of devices. The computer device may include a client-server device, a cloud computing device, an IoT device, or the like. Various data and information may have, for example, a structure such as a table or a list, but are not limited thereto. Expressions such as identification information, an identifier, an ID, a name, and a number can be replaced with each other.

### First Embodiment

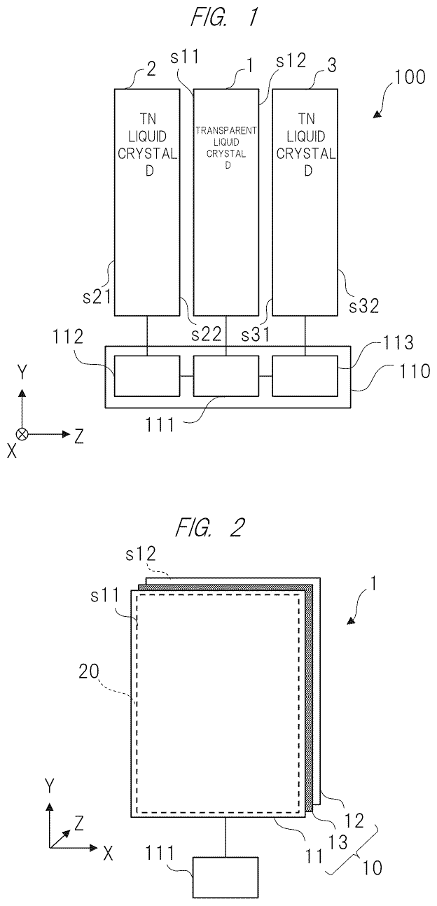

Hereinafter, a transparent liquid crystal display device 100 according to a first embodiment will be described with reference to FIG. 1 to FIG. 11. The transparent liquid crystal display device 100 according to the first embodiment includes a transparent liquid crystal display 1 illustrated in FIG. 1 and the like, TN liquid crystal displays 2 and 3, and a general controller 110 that controls these displays. The transparent liquid crystal display 1 displays information on a screen 20 having optical transparency.

The transparent liquid crystal display device 100 can be installed and used at an arbitrary position. For example, the transparent liquid crystal display device 100 can be installed at a counter where a person faces a person, a service counter, a partition between a person and a person, a show window glass of a shop or the like.

### <Configuration of Transparent Liquid Crystal Display Device>

FIG. 1 is a schematic diagram illustrating an example of a configuration of the transparent liquid crystal display device 100. As illustrated in FIG. 1, the transparent liquid crystal display device 100 includes the transparent liquid crystal display 1 (a transparent liquid crystal display unit), the TN liquid crystal display 2 (a first display unit), the TN liquid crystal display 3 (a second display unit), and the general controller 110 (a control unit). The general controller 110 includes controllers 111, 112, and 113. The controller 111 is a controller that performs display control of the transparent liquid crystal display 1. The controller 112 is a controller that performs display control of the TN liquid crystal display 2. The controller 112 performs transition for an area that is included in the TN liquid crystal display 2 and covers a screen (display area) of the transparent liquid crystal display 1 between a black display state in which black is displayed and a transparent state in which light is transmitted. The controller 113 is a controller that performs display control of the TN liquid crystal display 3. The controller 113 performs transition for an area that is included in the TN liquid crystal display 3 and covers a screen (display area) of the transparent liquid crystal display 1 between a black display state in which black is displayed and a transparent state in which light is transmitted.

The transparent liquid crystal display 1 and the TN liquid crystal displays 2 and 3 are provided such that display surfaces of the displays overlap each other. In FIG. 1, a direction in which the display surfaces of the transparent liquid crystal display 1 and the TN liquid crystal displays 2 and 3 overlap each other is defined as a Z direction. A Y direction orthogonal to the Z direction is a longitudinal direction (vertical direction) in FIG. 1, and an X direction orthogonal to the Z direction and the Y direction is a direction toward a paper surface in FIG. 1. Further, in FIG. 1 and the like, the transparent liquid crystal display 1 and the TN liquid crystal display 2 are separated from each other, and the transparent liquid crystal display 1 and the TN liquid crystal display 3 are separated from each other. On the other hand, the transparent liquid crystal display 1 and the TN liquid crystal display 2 may be in close contact with each other, and the transparent liquid crystal display 1 and the TN liquid crystal display 3 may be in close contact with each other.

### <Transparent Liquid Crystal Display>

FIG. 2 is a schematic diagram illustrating an example of a configuration of the transparent liquid crystal display 1 according to the first embodiment. The transparent liquid crystal display 1 includes a transparent liquid crystal display that is a main body 10 and the controller 111 connected to the main body 10. The transparent liquid crystal display 1 has a first surface s11 and a second surface s12 facing the first surface s11. In the transparent liquid crystal display 1, information displayed on the transparent liquid crystal display is recognized by users from each of the first surface s11 side and the second surface s12 side. Here, the information is, for example, any of image information representing an image, video information representing a video, character information representing a character, and composite information obtained by combining image information, video information, and character information. Hereinafter, a case where an image is displayed will be mainly described.

The transparent liquid crystal display 1 includes the main body 10 including a first substrate 11, a second substrate 12, and a display layer 13, which are included in a screen 20. The controller 111 is electrically connected to the main body 10. The display layer 13 includes a plurality of pixels included in a display area corresponding to the screen 20 as described later.

The main body 10 and the screen 20 have the first surface s11 on the first substrate 11 side and the second surface s12 on the second substrate 12 side. The transparent liquid crystal display 1 can display information such as a video toward a user on the first surface s11 side, or can display information such as a video toward a user on the second surface s12 side by controlling the display layer 13. In a case where information such as an image or a video is displayed on the screen 20 in response to the control of the display layer 13 in the transparent liquid crystal display 1, the display image can be visually recognized by both the user on the first surface s11 side and the user on the second surface s12 side.

The controller 111 displays information such as an image and a video on the screen 20 by controlling a display state of pixels included in a liquid crystal layer that is the display layer 13. The controller 111 may be incorporated in the main body 10, or may be connected to the outside of the main body 10. For example, in addition to a drive circuit and the like, a control circuit including the controller 111 may be mounted on a part of the first substrate 11 or the second substrate 12. The controller 111 may be a device such as a PC that is provided outside the main body 10. In addition, although not illustrated, a microphone, a speaker, a lamp, and the like may be installed in and connected to the main body 10.

In the transparent liquid crystal display 1 illustrated in FIG. 2, in particular, the controller 111 may be connected to an external device through a predetermined communication interface, for example, an HDMI interface. For example, the transparent liquid crystal display 1 may receive, as an input, a video signal from a video source device as an external device, and display the video signal on the screen 20. In this case, the transparent liquid crystal display 1 functions as a monitor display.

### <Example of Configuration of Transparent Liquid Crystal Display>

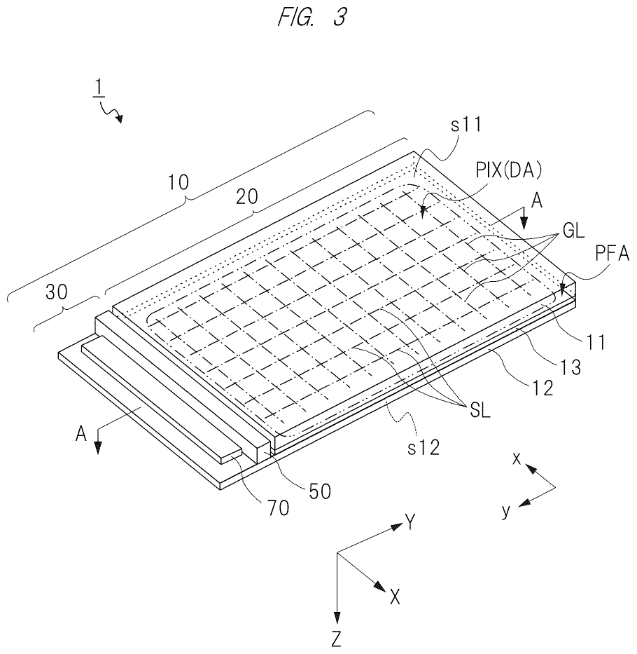

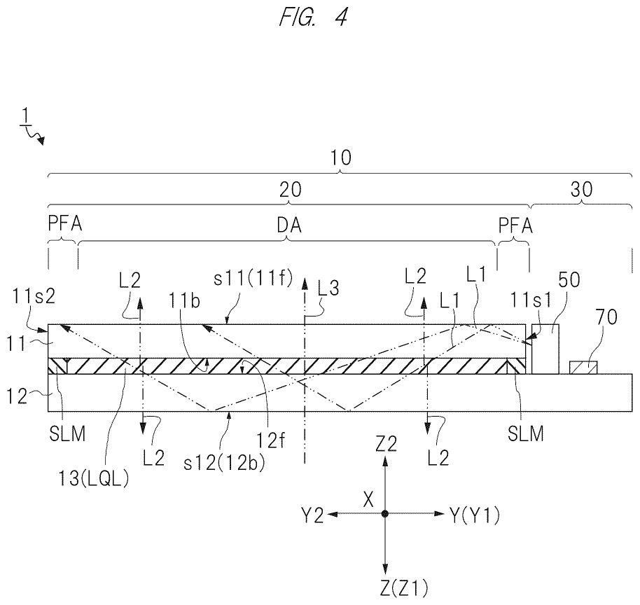

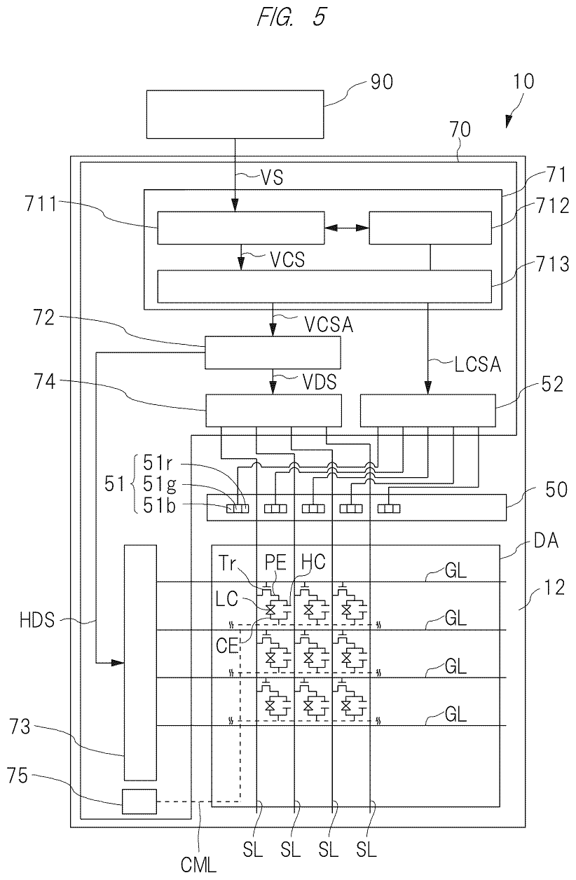

Next, an example of a configuration of the transparent liquid crystal display 1 will be described with reference to FIG. 3 to FIG. 5. FIG. 3 is a perspective view illustrating an outline of an example of a configuration of the main body 10 of the transparent liquid crystal display 1. FIG. 4 is a cross-sectional view taken along line A-A in FIG. 3, and schematically illustrates a path and the like of light emitted from a light source unit 50 of the transparent liquid crystal display 1. FIG. 5 illustrates an example of a configuration of a circuit formed in the main body 10.

FIG. 3 is a perspective view mainly illustrating the first surface s11 of the transparent liquid crystal display that is the main body 10. The transparent liquid crystal display that is the main body 10 includes the first substrate 11, the second substrate 12, the display layer 13, the light source unit 50, and a drive circuit 70. In the Z direction, the first substrate 11, the display layer 13, the second substrate 12, and the second surface s12 are arranged from the first surface s11 side.

The first substrate 11 is an opposing substrate, the second substrate 12 is an array substrate, and the display layer 13 is a liquid crystal layer. Pixels PIX in the display layer 13 of the screen 20 emit light in all directions.

In FIG. 3, in accordance with the coordinate system of FIG. 1, a direction along a thickness direction of the transparent liquid crystal display that is the main body 10 is defined as the Z direction, an extending direction of one side of the transparent liquid crystal display in an X-Y plane orthogonal to the Z direction is defined as the X direction, and a direction perpendicular to the X direction is defined as the Y direction. In addition, as a coordinate system (x, y) in the screen 20, an x direction corresponding to the X direction is a horizontal direction (in-screen horizontal direction), and a y direction corresponding to the Y direction is a vertical direction (in-screen vertical direction). In the present embodiment, the screen 20 is a vertically-long screen in which the size in the Y direction (y direction) is larger than the size in the X direction (x direction), but is not limited thereto.

The first surface s11 has a display area DA and a peripheral area PFA that correspond to the screen 20. Note that, in the present embodiment, the peripheral area PFA is also a part of the screen 20. The display area DA included in the screen 20 is located in an area where the first substrate 11, the second substrate 12, and the display layer 13 overlap each other when viewed in plan view in the Z direction. The peripheral area PFA is located outside the display area DA. A boundary between the display area DA and the peripheral area PFA is indicated by a two-dot chain line.

The display area DA is an area where an image or a video is formed according to an input signal supplied from the outside. The display area DA is an effective area in which an image or a video is displayed when the first surface s11 is viewed or the second surface s12 is viewed in plan view, for example, in the Z direction. In the display layer 13 corresponding to the display area DA, a plurality of pixels PIX is formed in a matrix pattern.

The peripheral area PFA is an area including four sides around the display area DA, in other words, a frame area, and an image or a video is not displayed.

As illustrated in FIG. 3, in the present example, the second substrate 12 has a larger width than the first substrate 11 in the Y direction. The second substrate 12 has an area 30 extended to one side in the Y direction on the first surface s11 side, that is, a left side area in the present embodiment. The light source unit 50 and the drive circuit 70 are mounted in the area 30.

The light source unit 50 is disposed along the peripheral area PFA on the left side of the screen 20. The light source unit 50 generates light source light for liquid crystal display on the display layer 13, and supplies the light source light to the display layer 13.

The drive circuit 70 generates an electric signal for driving the first substrate 11, the second substrate 12, the display layer 13, and the light source unit 50, and supplies the electric signal to each unit. In FIG. 3, among the circuits included in the transparent liquid crystal display, some of signal wirings that transmit the signals for driving the liquid crystal corresponding to the pixels PIX, specifically, a gate line GL and a source line SL, which will be described later, are schematically indicated by a one-dotted chain line.

The transparent liquid crystal display 1 may include, for example, a control circuit, a flexible printed circuit board, a housing, and the like in addition to the components illustrated in FIG. 3. A part of the drive circuit may be mounted in the peripheral area PFA. Examples of the housing include a housing that fixes the first substrate 11, the display layer 13, and the second substrate 12. These components are omitted in FIG. 3. Further, in the present embodiment, the display area DA is a quadrangle, but is not limited thereto, and may have another shape such as a polygon or a circle. Furthermore, in the present example, the light source unit 50 and the drive circuit 70 are mounted in the area 30, but the present disclosure is not limited thereto. As a modification example, separately from the first substrate 11 and the second substrate 12, a light source substrate and a drive circuit substrate (not illustrated) may be attached to the peripheral area PFA, and the light source unit 50 may be mounted on the light source substrate or the drive circuit 70 may be mounted on the drive circuit substrate.

In the cross-sectional view taken along line Y-Z in FIG. 4, an optical path of light emitted from the light source unit 50, a state of the liquid crystal, and the like in the transparent liquid crystal display that is the main body 10 will be described. The transparent liquid crystal display that is the main body 10 includes the first substrate 11 and the second substrate 12 which are bonded to each other so as to face each other via a liquid crystal layer LQL that is the display layer 13. The first substrate 11 and the second substrate 12 are arranged in the Z direction which is the thickness direction of the transparent liquid crystal display via the liquid crystal layer LQL. In other words, the first substrate 11 and the second substrate 12 face each other in the Z direction which is the thickness direction of the transparent liquid crystal display.

An array substrate that is the second substrate 12 has a front surface 12f facing the liquid crystal layer LQL and the first substrate 11. The opposing substrate that is the first substrate 11 has a back surface 11b facing the front surface 12f of the second substrate 12 and the liquid crystal layer LQL. The liquid crystal layer LQL including a liquid crystal is located between the front surface 12f of the second substrate 12 and the back surface 11b of the first substrate 11. In other words, the liquid crystal layer LQL is an optical modulation element.

The second substrate 12 is an array substrate in which a plurality of transistors (in other words, transistor elements) as switching elements (in other words, active elements) to be described later is disposed in an array. Since the first substrate 11 is a substrate disposed opposite to the array substrate that is the second substrate 12, the first substrate 11 can be referred to as an opposing substrate.

The transparent liquid crystal display that is the main body 10 has a function of modulating light passing through the liquid crystal of the liquid crystal layer LQL by controlling a state of an electric field formed around the liquid crystal layer LQL via the switching elements. The display area DA is provided in an area overlapping the liquid crystal layer LQL.

The first substrate 11 and the second substrate 12 are bonded to each other via seal portions (in other words, sealing materials) SLM. The seal portions SLM are disposed so as to surround the periphery of the display area DA. The liquid crystal layer LQL is provided inside the seal portions SLM. The seal portions SLM serve for sealing the liquid crystal between the first substrate 11 and the second substrate 12 and as a bonding material for bonding the first substrate 11 and the second substrate 12.

The light source unit 50 is disposed at a position facing one side surface 11s1 of the first substrate 11. Light source light L1 that is light emitted from the light source unit 50 is schematically indicated by a two-dotted chain line. As illustrated in FIG. 4, the light source light L1 emitted from the light source unit 50 in the Y direction propagates in a direction away from the side surface 11s1, that is, in a direction Y2 in the present embodiment, while being reflected by the second surface s12 that is the back surface 12b of the second substrate 12 and the first surface s11 that is the front surface 11f of the first substrate 11. In the propagation path of the light source light L1, the back surface 12b of the second substrate 12 and the front surface 11f of the first substrate 11 are interfaces between a medium having a large refractive index and a medium having a small refractive index. Therefore, in a case where an incident angle at which the light source light L1 is incident on the front surface 11f and the back surface 12b is larger than a critical angle, the light source light L1 is totally reflected by the front surface 11f and the back surface 12b.

The liquid crystal of the liquid crystal layer LQL is a polymer-dispersed liquid crystal, and includes a liquid crystal polymer and liquid crystal molecules. The liquid crystal polymer is formed in a streak shape, and the liquid crystal molecules are dispersed in a gap of the liquid crystal polymer. Each of the liquid crystal polymer and the liquid crystal molecules has optical anisotropy or refractive index anisotropy. Responsiveness of the liquid crystal polymer to an electric field is lower than responsiveness of the liquid crystal molecules to an electric field. The alignment direction of the liquid crystal polymer hardly changes regardless of the presence or absence of the electric field.

On the other hand, the alignment direction of the liquid crystal molecules changes according to the electric field in a state where a high voltage equal to or higher than a threshold value is applied to the liquid crystal. In a state where a voltage is not applied to the liquid crystal, optical axes of the liquid crystal polymer and the liquid crystal molecules are parallel to each other, and the light source light L1 that is incident on the liquid crystal layer LQL is transmitted almost without being scattered in the liquid crystal layer LQL. Such a state may be referred to as a transparent state.

In a state where a voltage is applied to the liquid crystal, the optical axes of the liquid crystal polymer and the liquid crystal molecules cross each other, and the light source light L1 that is incident on the liquid crystal is scattered in the liquid crystal layer LQL. Such a state may be referred to as a scattered state (in other words, a display state).

The transparent liquid crystal display that is the main body 10, specifically, the control circuit and the drive circuit 70 control the transparent state and the scattered state (in other words, the display state) by controlling the alignment of the liquid crystal in the propagation path of the light source light L1. In the scattered state, the light source light L1 is emitted to the outside of the transparent liquid crystal display from the first surface s11 side that is the front surface 11f and the second surface s12 side that is the back surface 12b, as emitted light L2 by the liquid crystal. The emitted light L2 corresponds to display image light.

Further, background light L3 that is incident from the second surface s12 side that is the back surface 12b is transmitted through the second substrate 12, the liquid crystal layer LQL, and the first substrate 11, and is emitted to the outside from the first surface s11 that is the front surface 11f.

The emitted light L2 and the background light L3 are visually recognized by a user on the first surface s11 side. The emitted light L2 corresponds to image light DGL1, and the background light L3 corresponds to background light BGL1. The user can recognize the emitted light L2 and the background light L3 in a form obtained by combining the emitted light L2 and the background light L3. As described above, the transparent liquid crystal display is a display panel capable of allowing a user to recognize a display image and a background in a form obtained by superimposing the display image and the background.

In the case of the transparent liquid crystal display of FIG. 4, in order to ensure visible light transmittance of the first surface s11 and the second surface s12, the light source unit 50 is disposed at a position not overlapping the display area DA in plan view. In addition, the transparent liquid crystal display reflects the light source light L1 by using a refractive index difference between the first substrate 11 and the second substrate 12, which function as a light guide member, and the surrounding air layer. Thereby, the transparent liquid crystal display includes a mechanism that delivers light to an opposite side surface 11s2 facing the light source unit 50.

An example of a configuration of a circuit included in the transparent liquid crystal display that is the main body 10 will be described with reference to FIG. 5. FIG. 5 illustrates an example of a configuration of the drive circuit 70, the light source unit 50, and the pixels PIX (FIG. 3) in the display area DA. A control unit 90 including a control circuit that controls display of an image is connected to the drive circuit 70. The control unit 90 is included in, for example, the general controller 110 illustrated in FIG. 1. Alternatively, the control unit 90 may be mounted on the transparent liquid crystal display together with the drive circuit 70.

The drive circuit 70 includes a signal processing circuit 71, a pixel control circuit 72, a gate drive circuit 73, a source drive circuit 74, a common potential drive circuit 75, and a light source control unit 52. Further, the light source unit 50 includes, for example, a light emitting diode element 51r (for example, red), a light emitting diode element 51g (for example, green), and a light emitting diode element 51b (for example, blue).

The signal processing circuit 71 includes an input signal analysis unit 711, a storage unit 712, and a signal adjustment unit 713. An input signal VS is input from the control unit 90 to the input signal analysis unit 711 of the signal processing circuit 71 via a wiring path such as a flexible printed circuit board (not illustrated). The input signal analysis unit 711 performs analysis processing based on the input signal VS which is input, and generates an input signal VCS. The input signal VCS is, for example, a signal for determining a gradation value to be assigned to each pixel PIX (FIG. 3) based on the input signal VS.

The signal adjustment unit 713 generates an input signal VCSA from the input signal VCS which is input from the input signal analysis unit 711. The signal adjustment unit 713 transmits the input signal VCSA to the pixel control circuit 72, and transmits a light source control signal LCSA to the light source control unit 52. The light source control signal LCSA is, for example, a signal including information related to a light amount of the light source unit 50 that is set according to the input gradation value to the pixel PIX.

The pixel control circuit 72 generates a horizontal drive signal HDS and a vertical drive signal VDS based on the input signal VCSA. For example, in the present embodiment, the plurality of pixels PIX is driven by a field sequential system. Therefore, in the pixel control circuit 72, the horizontal drive signal HDS and the vertical drive signal VDS are generated for each of the colors that can be emitted by the light source unit 50.

The gate drive circuit 73 sequentially selects gate lines GL (in other words, signal wirings) of the transparent liquid crystal display within one vertical scanning period based on the horizontal drive signal HDS. The order of selection of the gate lines GL is arbitrary. As illustrated in FIG. 3, the plurality of gate lines GL extends in the X direction (x direction), and are arrayed along the Y direction (y direction).

The source drive circuit 74 supplies a gradation signal according to the output gradation value of each pixel PIX to source lines SL (in other words, signal wirings) of the transparent liquid crystal display within one horizontal scanning period based on the vertical drive signal VDS. As illustrated in FIG. 3, a plurality of source lines SL extends in the Y direction (y direction), and is arrayed along the X direction (x direction). One pixel PIX is formed for each intersection of the gate lines GL and the source lines SL.

A switching element Tr is formed at each portion where the gate line GL and the source line SL intersect with each other. The plurality of gate lines GL and the plurality of source lines SL correspond to a plurality of signal wirings that transmit a drive signal for driving the liquid crystal of the liquid crystal layer LQL in FIG. 4.

As the switching element Tr, for example, a thin film transistor is used. A type of the thin film transistor is not particularly limited. One of a source electrode and a drain electrode of the switching element Tr is connected to the source line SL, a gate electrode of the switching element Tr is connected to the gate line GL, and the other of the source electrode and the drain electrode of the switching element Tr is connected to one end of a capacitor of the polymer-dispersed liquid crystal LC (corresponding to the liquid crystal of the liquid crystal layer LQL in FIG. 4). One end of the capacitor of the polymer-dispersed liquid crystal LC is connected to the switching element Tr via a pixel electrode PE, and the other end of the capacitor of the polymer-dispersed liquid crystal LC is connected to the common potential wiring CML via a common electrode CE. In addition, a holding capacitor HC is provided between the pixel electrode PE and a holding capacitor electrode that is electrically connected to the common potential wiring CML. The common potential wiring CML is supplied from the common potential drive circuit 75. The wiring path connected to the common electrode CE in FIG. 5 is formed, for example, on the first substrate 11 in FIG. 3. In FIG. 5, the wiring formed on the first substrate 11 is indicated by a dotted line.

In the example of a configuration illustrated in FIG. 5, the drive circuit 70 includes the light source control unit 52. As a modification example, the light source unit 50 and the light source control unit 52 may be provided separately from the drive circuit 70. As described above, in a case where the light source unit 50 is mounted on a light source substrate different from the second substrate 12, the light source control unit 52 may be formed on the light source substrate or may be formed in an electronic component mounted on the light source substrate.

### <TN Liquid Crystal Display>

Next, the TN liquid crystal displays 2 and 3 will be described. As illustrated in FIG. 1, the TN liquid crystal display 2 has a first surface s21 and a second surface s22 facing the first surface s21. The TN liquid crystal display 3 has a first surface s31 and a second surface s32 facing the first surface s31. The transparent liquid crystal display device 100 is configured such that the second surface s22 of the TN liquid crystal display 2 faces the first surface s11 of the transparent liquid crystal display 1 and that the second surface s12 of the transparent liquid crystal display 1 faces the first surface s31 of the TN liquid crystal display 3. That is, the transparent liquid crystal display device 100 is configured such that the screen (display area) 20 of the transparent liquid crystal display 1 is sandwiched between the display areas of the TN liquid crystal displays 2 and 3.

The TN liquid crystal display 2 can transition between a black display state in which black is displayed and a transparent display state in which light is transmitted based on a control instruction of the controller 112. The TN liquid crystal display 3 can transition between a black display state in which black is displayed and a transparent display state in which light is transmitted based on a control instruction of the controller 113.

In the TN liquid crystal displays 2 and 3, transition between the black display state and the transparent display state is performed by controlling a twisted state of the liquid crystal layer according to a level of the voltage and adjusting the intensity of the light transmitted from the backlight. The TN liquid crystal displays 2 and 3 are configured such that liquid crystal layers arranged in the horizontal direction are sandwiched between polarizing filters shifted from each other by 90 degrees. When the voltage is off, the liquid crystal molecules of the liquid crystal layer are oriented in the same direction near each polarizing filter, and are gradually twisted in the liquid crystal layer. Since polarized light of the backlight light also rotates along the twist, the light is transmitted in a voltage-off state. At this time, the TN liquid crystal displays 2 and 3 enter into a transparent display state. On the other hand, when a voltage is applied, the liquid crystal layer corresponding to the pixels rises vertically, and the twisted structure is broken. As a result, polarized light does not rotate in a maximum voltage state, and the backlight light is blocked. At this time, the TN liquid crystal displays 2 and 3 enter into a black display state.

### <Display Control>

Next, display control of the transparent liquid crystal display device 100 will be described.

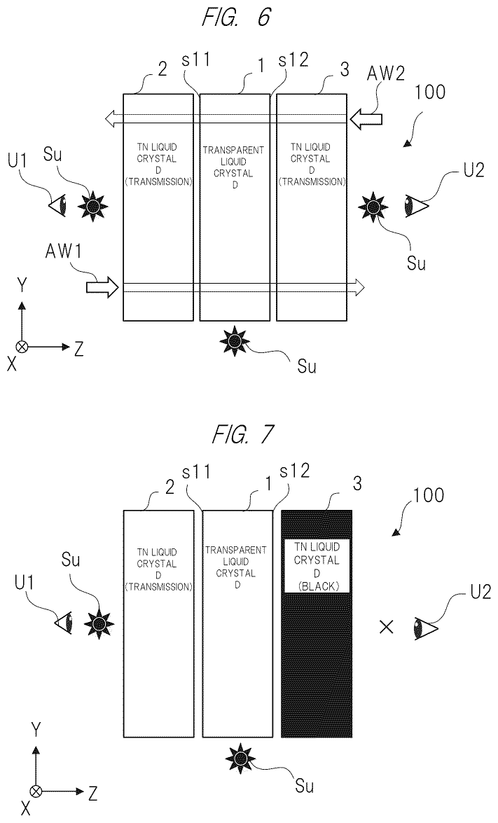

FIG. 6 is a schematic diagram illustrating an example of a first double-sided viewing state. The first double-sided viewing state is a state in which the same information displayed on the transparent liquid crystal display 1 can be visually recognized from both the TN liquid crystal display 2 side and the TN liquid crystal display 3 side in the transparent liquid crystal display device 100. Therefore, light indicated by an arrow AW1 is transmitted through the TN liquid crystal display 2, the transparent liquid crystal display 1, and the TN liquid crystal display 3. Further, light indicated by an arrow AW2 is transmitted through the TN liquid crystal display 3, the transparent liquid crystal display 1, and the TN liquid crystal display 2. Thereby, a user U1 located on the left side of the TN liquid crystal display 2 and a user U2 located on the right side of the TN liquid crystal display 3 can respectively visually recognize the information displayed on the transparent liquid crystal display 1. However, the information is visually recognized in the opposite direction on one side.

For example, as illustrated in FIG. 6, the transparent liquid crystal display 1 displays an image of the sun Su. Each of the TN liquid crystal displays 2 and 3 is in a transmission state (transparent display state). Therefore, the user U1 can visually recognize the image of the sun Su displayed on the transparent liquid crystal display 1 via the TN liquid crystal display 2. Further, the user U2 can visually recognize the image of the sun Su displayed on the transparent liquid crystal display 1 via the TN liquid crystal display 3. That is, in the first double-sided viewing state, both the user U1 and the user U2 can visually recognize the sun Su which is the same image.

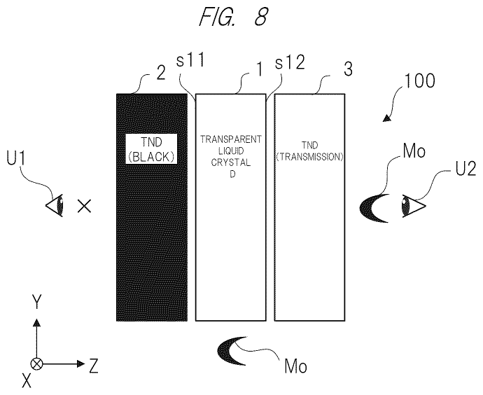

FIG. 7 and FIG. 8 are schematic diagrams illustrating an example of a single-side viewing state. The single-side viewing state is a state in which information displayed on the transparent liquid crystal display 1 can be visually recognized from either the TN liquid crystal display 2 side or the TN liquid crystal display 3 side. FIG. 7 illustrates a state in which information displayed on the transparent liquid crystal display 1 can be visually recognized only from the TN liquid crystal display 2 side. FIG. 8 illustrates a state in which information displayed on the transparent liquid crystal display 1 can be visually recognized only from the TN liquid crystal display 3 side.

For example, as illustrated in FIG. 7, in a case where the TN liquid crystal display 2 is in the transmission state (transparent display state) and the TN liquid crystal display 3 is in the black state (black display state), the user U1 can visually recognize the image (first information) of the sun Su displayed on the transparent liquid crystal display 1, but the user U2 can visually recognize only the black color.

For example, as illustrated in FIG. 8, in a case where the TN liquid crystal display 2 is in the black state (black display state) and the TN liquid crystal display 3 is in the transmission state (transparent display state), the user U2 can visually recognize the image (second information) of the moon Mo displayed on the transparent liquid crystal display 1, but the user U1 can visually recognize only the black color. That is, according to the examples of FIG. 7 and FIG. 8, the user U1 and the user U2 can visually recognize different pieces of information. That is, the user U1 can visually recognize the sun Su, and the user U2 can visually recognize the moon Mo.

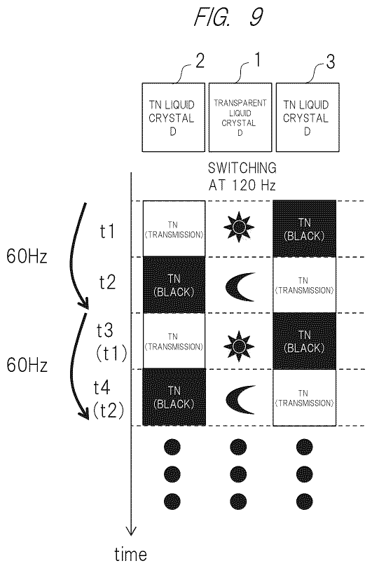

FIG. 9 is a diagram illustrating an example of high-speed switching control for switching the states described with reference to FIG. 7 and FIG. 8 at high speed. By executing high-speed switching control in this manner, a second double-sided viewing state can be obtained. The second double-sided viewing state is a state in which pieces of different information displayed on the transparent liquid crystal display 1 can be visually recognized from the TN liquid crystal display 2 side and the TN liquid crystal display 3 side in the transparent liquid crystal display device 100.

As illustrated in FIG. 9, the controller 111 performs display control to repeat a first display period and a second display period. The first display period is a time t1, and the second display period is a time t2. Each of the time t1 and the time t2 is, for example, 1/120 second. That is, the information is displayed by performing switching at an interval of 120 Hz. Note that each of the time t1 and the time t2 may be equal to or shorter than 1/120 second. In short, each of the time t1 and the time t2 is a short time, and may be any time as long as the display can be switched at high speed.

In the first display period, the controller 111 displays the image of the sun Su on the transparent liquid crystal display 1, the controller 112 causes the TN liquid crystal display 2 to transition to the transparent display state, and the controller 113 causes the TN liquid crystal display 3 to transition to the black display state. Thereby, in the first display period, the user U1 can recognize the image of the sun Su displayed on the transparent liquid crystal display 1 through the TN liquid crystal display 2 in the transparent display state, but the user U2 cannot recognize the image of the sun Su through the TN liquid crystal display 3 in the black display state.

In the second display period, the controller 111 displays the image of the moon Mo on the transparent liquid crystal display 1, the controller 112 causes the TN liquid crystal display 2 to transition to the black display state, and the controller 113 causes the TN liquid crystal display 3 to transition to the transparent display state. Thereby, in the second display period, the user U1 cannot visually recognize the image of the moon Mo displayed on the transparent liquid crystal display 1 through the TN liquid crystal display 2 in the black display state, but the user U2 can visually recognize the image of the moon Mo through the TN liquid crystal display 3 in the transparent display state.

At a time t3 which is the next first display period, the same display control as the display control at the time t1 is performed, and at a time t4 which is the next second display period, the same display control as the display control at the time t2 is performed. As described above, display control of repeating the first display period and the second display period is executed at high speed.

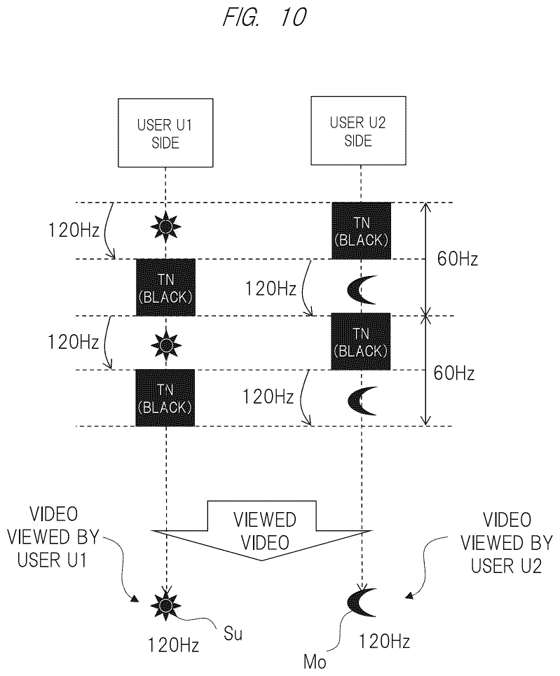

FIG. 10 is a diagram for explaining an example of display on the transparent liquid crystal display device 100 in a case where the general controller 110 performs high-speed switching control illustrated in FIG. 9. By performing high-speed switching control, as illustrated in FIG. 10, on the user U1 side, display control is performed in which the image of the sun Su is displayed at 120 Hz, black display is performed at 120 Hz, the image of the sun Su is displayed at 120 Hz, and black display is performed at 120 Hz. Thereby, the image that can be visually recognized by the user U1 is the image of the sun Su. On the other hand, in the transparent liquid crystal display device 100, on the user U2 side, display control is performed in which black display is performed at 120 Hz, the image of the moon Mo is displayed at 120 Hz, black display is performed at 120 Hz, and the image of the moon Mo is displayed at 120 Hz. Thereby, the image that can be visually recognized by the user U2 is the image of the moon Mo.

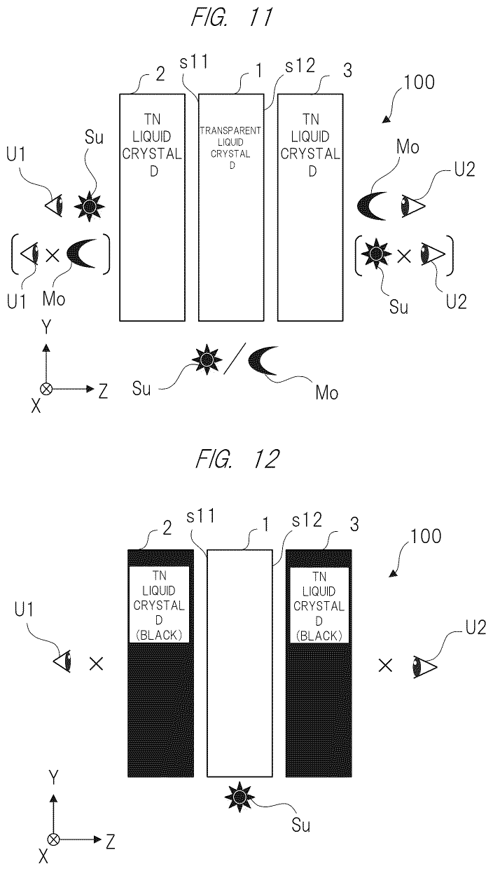

FIG. 11 is a diagram for explaining an operation of the transparent liquid crystal display device 100 in a case where high-speed switching control is performed. As illustrated in FIG. 11, the user U1 can visually recognize the image of the sun Su displayed on the transparent liquid crystal display 1 through the TN liquid crystal display 2 in the transparent display state, but cannot visually recognize the image of the moon Mo. On the other hand, the user U2 can visually recognize the image of the moon Mo displayed on the transparent liquid crystal display 1 through the TN liquid crystal display 3 in the transparent display state, but cannot visually recognize the image of the sun Su. That is, in the second double-sided viewing state, the user U1 and the user U2 can visually recognize pieces of different information.

Whether the transparent liquid crystal display device 100 operates in the first double-sided viewing state or the second double-sided viewing state may be determined based on, for example, an instruction from a host device connected to the general controller 110.

As described above, according to the transparent liquid crystal display device 100, information to be displayed for the user U1 can be displayed on the user U1 side, and information to be displayed for the user U2 can be displayed on the user U2 side. That is, the transparent liquid crystal display device 100 can distinguish and display information to be displayed on the TN liquid crystal display 2 side and information to be displayed on the TN liquid crystal display 3 side. Therefore, the transparent liquid crystal display device 100 can display appropriate information on both display surfaces.

Note that, in the above embodiment, the case where the transparent liquid crystal display device 100 uses the TN liquid crystal displays 2 and 3 suitable for high-speed switching control has been described, but the configuration for realizing the transparent liquid crystal display device 100 is not limited thereto. For example, instead of the TN liquid crystal display, a chromism device or a dimming device may be used. In this case, the chromium device or the dimming device is caused to transition between the black display state and the transparent display state.

Further, according to the high-speed switching control of the transparent liquid crystal display device 100, for example, the user U1 visually recognizes a video at 120 Hz out of 60 Hz, but recognizes black at the remaining 120 Hz. Therefore, information to be displayed on the transparent liquid crystal display 1 may be visually recognized in a blackish color. In order to prevent this problem, the transparent liquid crystal display device 100 may adjust a hue, brightness, and saturation of an image to be displayed. That is, the general controller 110 may adjust a hue, brightness, and saturation of information to be displayed on the first surface s11 side according to a time of the black display state to be displayed on the TN liquid crystal display 2. Further, the general controller 110 may adjust a hue, brightness, and saturation of information to be displayed on the second surface s12 side according to a time of the black display state to be displayed on the TN liquid crystal display 3.

For example, the general controller 110 adjusts any one of a hue, brightness, and saturation of information such as an image to be displayed such that the information is brightly displayed on the transparent liquid crystal display 1. That is, adjustment is performed such that information such as an image to be displayed in a blackish color is visually recognized with brightness to be originally displayed. Thereby, even in a case where the high-speed switching control is performed, the transparent liquid crystal display device 100 can allow the user to visually recognize a video with brightness to be originally displayed in the video.

Note that, in the above embodiment, the case where the transparent liquid crystal display device 100 performs switching of the display surface on which information such as an image is displayed at a total of 60 Hz in which the first display period is 120 Hz and the second display period is 120 Hz has been described, but the display switching timing is not limited thereto.

### <Modification Example>

FIG. 12 is a diagram for explaining a modification example of the display control of the transparent liquid crystal display device 100. As illustrated in FIG. 12, in the transparent liquid crystal display device 100, both the TN liquid crystal displays 2 and 3 are in the black display state.

For example, in a case where the general controller 110 receives an instruction for double-sided black display or an instruction for display restriction of a video to be displayed on the transparent liquid crystal display 1, the controller 112 causes the TN liquid crystal display 2 to transition to the black display state, and the controller 113 causes the TN liquid crystal display 3 to transition to the black display state. Thereby, the transparent liquid crystal display device 100 can prevent the users U1 and U2 from visually recognizing information to be displayed on the transparent liquid crystal display 1 based on the instruction for double-sided black display or the instruction for display restriction. Therefore, the transparent liquid crystal display device 100 can improve security of information disclosure.

### Second Embodiment

A second embodiment is different from the first embodiment in configurations of the transparent liquid crystal display and the TN liquid crystal display in the transparent liquid crystal display device.

### <Configuration of Transparent Liquid Crystal Display Device>

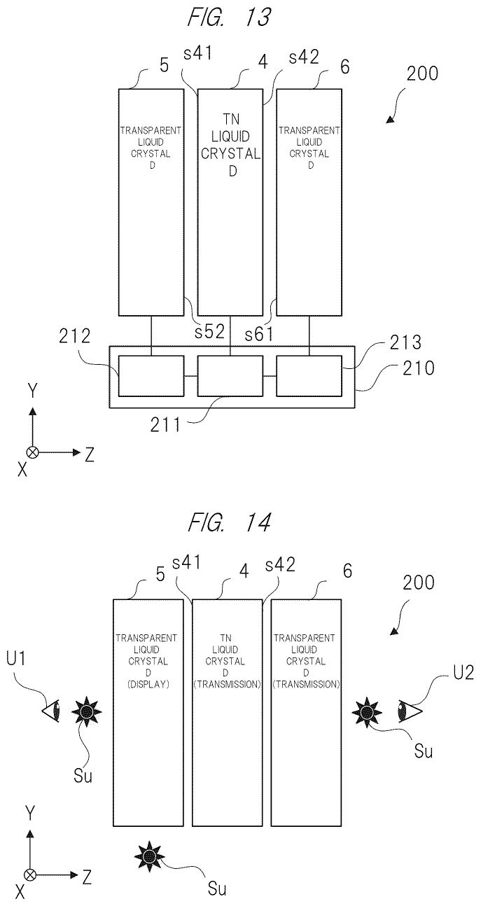

FIG. 13 is a schematic diagram illustrating an example of a configuration of a transparent liquid crystal display device 200. As illustrated in FIG. 13, the transparent liquid crystal display device 200 includes a TN liquid crystal display 4, transparent liquid crystal displays 5 and 6, and a general controller 210. The general controller 210 includes controllers 211, 212, and 213. The controller 211 is a controller that performs display control of the TN liquid crystal display 4. The controller 212 is a controller that performs display control of the transparent liquid crystal display 5. The controller 213 is a controller that performs display control of the transparent liquid crystal display 6.

The TN liquid crystal display 4 can transition between a black display state and a transparent display state based on a control instruction of the controller 212. The transparent liquid crystal display 5 can transition between a transparent display state and a display state. The transparent liquid crystal display 6 can transition between a transparent display state and a display state.

The TN liquid crystal display 4 and the transparent liquid crystal displays 5 and 6 are provided such that the display surfaces overlap each other. In FIG. 13, a direction in which the display surfaces of the TN liquid crystal display 4 and the transparent liquid crystal displays 5 and 6 overlap each other is defined as a Z direction. A Y direction orthogonal to the Z direction is a longitudinal direction (vertical direction) in FIG. 13, and an X direction orthogonal to the Z direction and the Y direction is a direction toward a paper surface in FIG. 13.

FIG. 14 is a schematic diagram illustrating an example of display control of the transparent liquid crystal display device 200. In FIG. 14, the TN liquid crystal display 4 is in a transmission state (transparent display state), and the transparent liquid crystal display 6 is in a transmission state (transparent display state). In this case, in a case where the image of the sun Su is displayed on the transparent liquid crystal display 5, the user U1 can visually recognize the image of the sun Su displayed on the transparent liquid crystal display 5. On the other hand, the user U2 can visually recognize the image of the sun Su displayed on the transparent liquid crystal display 5 through the transparent liquid crystal display 6 and the TN liquid crystal display 4. Even in a case where display control is performed in this manner, the transparent liquid crystal display device 200 can realize double-sided viewing.

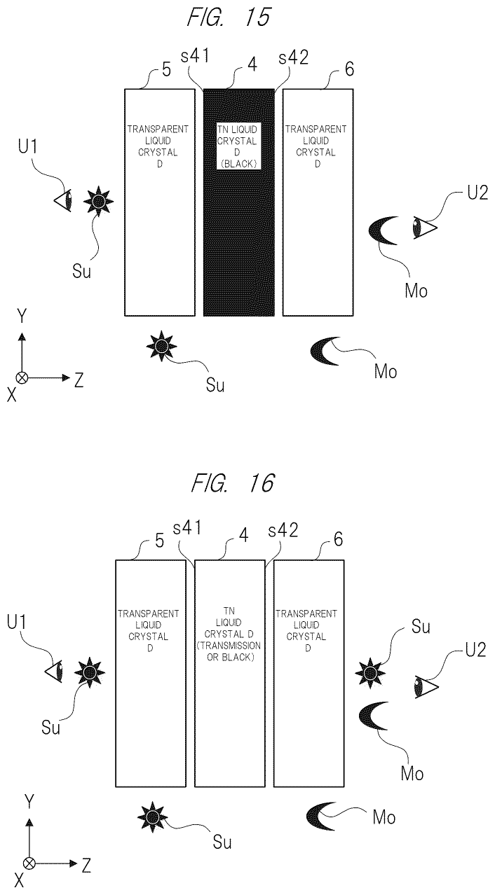

FIG. 15 is a schematic diagram illustrating an example of display control of the transparent liquid crystal display device 200. In FIG. 15, the TN liquid crystal display 4 is in a black state (black display state), the transparent liquid crystal display 5 displays the image of the sun Su, and the transparent liquid crystal display 6 displays the image of the moon Mo. In this case, the user U1 can visually recognize the image of the sun Su displayed on the transparent liquid crystal display 5, but cannot visually recognize the image of the moon Mo displayed on the transparent liquid crystal display 6 due to the black display of the TN liquid crystal display 4. On the other hand, the user U2 can visually recognize the image of the moon Mo displayed on the transparent liquid crystal display 6, but cannot visually recognize the image of the sun Su displayed on the transparent liquid crystal display 5 due to the black display of the TN liquid crystal display 4. Even in a case where display control is performed in this manner, the transparent liquid crystal display device 200 can realize double-sided viewing.

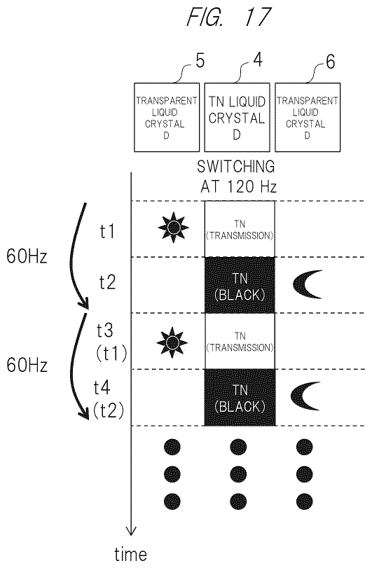

FIG. 16 is a schematic diagram illustrating an example of display control of the transparent liquid crystal display device 200. FIG. 17 is a diagram illustrating an example of high-speed switching control for realizing the display states described with reference to FIG. 16.

In FIG. 16, the TN liquid crystal display 4 is in a transmission state (transparent display state) or transitions to a black state (black display state), the transparent liquid crystal display 5 displays the image of the sun Su, and the transparent liquid crystal display 6 displays the image of the moon Mo.

As illustrated in FIG. 17, the TN liquid crystal display 4 is controlled to be in the transmission state (transparent display state) when the image of the sun Su is displayed on the transparent liquid crystal display 5, and to be in the black state (black display state) when the image of the moon Mo is displayed on the transparent liquid crystal display 6.

In a case where control is performed in this way, as illustrated in FIG. 16, the user U1 can visually recognize the image of the sun Su displayed on the transparent liquid crystal display 5, but cannot visually recognize the image of the moon Mo displayed on the transparent liquid crystal display 6 due to the black display of the TN liquid crystal display 4. On the other hand, the user U2 can visually recognize the image of the moon Mo displayed on the transparent liquid crystal display 6, and also can visually recognize the image of the sun Su displayed on the transparent liquid crystal display 5 since the TN liquid crystal display 4 is in the transmission state. Even in a case where display control is performed in this manner, the transparent liquid crystal display device 200 can realize double-sided viewing.

Which of the above-described double-sided viewing states is to be executed may be determined based on, for example, an instruction from a host device connected to the general controller 210.

Although various embodiments of the present invention have been described above, the present invention is not limited to the above-described embodiments, and includes various modification examples. In addition, the above-described embodiments have been described in detail in order to describe the present invention in an easy-to-understand manner, and are not necessarily limited to the configurations including all the described components. Further, a part of the configuration of one embodiment can be replaced with the configuration of another embodiment, and the configuration of another embodiment can be added to the configuration of one embodiment. These configurations are all within the scope of the present invention. Furthermore, numerical values and the like included in the specification and the drawings are merely examples, and the effect of the present invention is not impaired even in a case where different numerical values are used.

What is claimed is:

1. A transparent liquid crystal display device comprising:
a transparent liquid crystal display unit that has a first surface and a second surface opposite to the first surface;
a first display unit;
a second display unit; and
a control unit that performs display control of the transparent liquid crystal display unit, the first display unit, and the second display unit,
wherein the transparent liquid crystal display unit includes:
a first substrate having the first surface;
a second substrate having the second surface;
a display layer that is disposed between the first substrate and the second substrate and transitions between a transparent state in which light is transmitted and a display state in which information is displayed; and
a display area that is provided in an area where the first substrate, the second substrate, and the display layer overlap each other,
wherein the information is displayed to be visually recognized from the first surface side and the second surface side,
wherein, in the first display unit, one surface of a substrate is disposed on the first surface, and transition for an area that covers the display area is performed between a black display state in which black is displayed and a transparent state in which light is transmitted,
wherein, in the second display unit, one surface of a substrate is disposed on the second surface, and transition for an area that covers the display area is performed between a black display state in which black is displayed and a transparent display state in which light is transmitted, and
wherein the control unit is configured to:
perform display control to repeat a first display period and a second display period;
in the first display period, display first information to be displayed on the first surface side on the transparent liquid crystal display unit; cause the first display unit to transition to the transparent state; and cause the second display unit to transition to the black display state; and
in the second display period, display second information to be displayed on the second surface side on the transparent liquid crystal display unit; cause the first display unit to transition to the black display state; and
cause the second display unit to transition to the transparent state.

2. The transparent liquid crystal display device according to claim 1,
wherein, in a case where an instruction for black display or an instruction for display restriction is received, the control unit is configured to:
cause the first display unit and the second display unit to transition to the black display state in the first display period and the second display period.

3. The transparent liquid crystal display device according to claim 1,
wherein each of the first information and the second information is any one of image information representing an image, video information representing a video, character information representing a character, and composite information obtained by combining the image information, the video information, and the character information.

4. The transparent liquid crystal display device according to claim 1,
wherein each of the first display unit and the second display unit is a TN liquid crystal display device.

5. The transparent liquid crystal display device according to claim 1,
wherein each of the first display period and the second display period is equal to or shorter than 1/120 second.

6. The transparent liquid crystal display device according to claim 1,
wherein the control unit adjusts a hue, brightness, and saturation of the first information to be displayed on the first surface side according to a time of the black display state to be displayed on the first display unit.

7. The transparent liquid crystal display device according to claim 6,
wherein the control unit adjusts any one of the hue, brightness, and saturation of the first information such that the first information is brightly displayed on the transparent liquid crystal display unit.

8. The transparent liquid crystal display device according to claim 6,
wherein the control unit further adjusts a hue, brightness, and saturation of the second information to be displayed on the second surface side according to a time of the black display state to be displayed on the second display unit.

9. The transparent liquid crystal display device according to claim 8,
wherein the control unit adjusts any one of the hue, brightness, and saturation of the second information such that the second information is brightly displayed on the transparent liquid crystal display unit.
